(19) United States
(12) Patent Application Publication
(10) Pub. No.: US 2018/0336349 A1
(43) Pub. Date: Nov. 22, 2018

(54) TIMELY CAUSALITY ANALYSIS IN HOMEGENEOUS ENTERPRISE HOSTS

(71) Applicant: NEC Laboratories America, Inc., Princeton, NJ (US)

(72) Inventors: Mu Zhang, Plainsboro, NJ (US); Kangkook Jee, Princeton, NJ (US); Zhichun Li, Princeton, NJ (US); Ding Li, West Windsor, NJ (US); Zhenyu Wu, Plainsboro, NJ (US); Junghwan Rhee, Princeton, NJ (US)

(21) Appl. No.: 15/972,911

(22) Filed: May 7, 2018

Related U.S. Application Data
(60) Provisional application No. 62/507,908, filed on May 18, 2017.

(51) Int. Cl. G06F 21/55

(52) U.S. Cl. CPC G06F 21/554; G06F 2221/034

(57) ABSTRACT

A method and system are provided for causality analysis of Operating System-level (OS-level) events in heterogeneous enterprise hosts. The method includes storing, by the processor, the OS-level events in a priority queue in a prioritized order based on priority scores determined from event rareness scores and event fanout scores for the OS-level events. The method includes processing, by the processor, the OS-level events stored in the priority queue in the prioritized order to provide a set of potentially anomalous ones of the OS-level events within a set amount of time. The method includes generating, by the processor, a dependency graph showing causal dependencies of at least the set of potentially anomalous ones of the OS-level events, based on results of the causality dependency analysis. The method includes initiating, by the processor, an action to improve a functioning of the hosts responsive to the dependency graph or information derived therefrom.

### RELATED APPLICATION INFORMATION

This application claims priority to provisional application Ser. No. 62/507,908 filed on May 18, 2017 incorporated herein by reference.

### BACKGROUND

### Technical Field

The present invention relates to data processing, and more particularly to timely causality analysis in homogeneous enterprise hosts.

### Description of the Related Art

The increasingly sophisticated Advanced Persistent Threat (APT) attacks have become a serious challenge for enterprise Information Technology (IT) security. APT attaches are conducted in multiple stages, including initial comprise, internal reconnaissance, lateral movement, and eventually mission completion. Attack causality analysis, which tracks multi-hop causal relationships between files and processes to diagnose attack provenances and consequences, is the first step towards understanding APT attacks and taking appropriate responses. Since attack causality analysis is a time-critical mission, it is essential to design causality tracking systems that extract useful attack information in a timely manner. However, prior work is limited in serving this need. Existing approaches have largely focused on pruning causal dependencies totally irrelevant to the attack but fail to differentiate and prioritize abnormal events from numerous relevant, yet benign and complicated system operations, resulting in long investigation time and slow responses.

Accordingly, there is a need for an improved approach to timely causality analysis in homogeneous enterprise hosts.

### SUMMARY

According to an aspect of the present invention, a system is provided. The system includes a memory device for storing program code. The system further includes a priority queue. The system also includes a processor, operatively coupled to the memory device and the priority queue. The processor is configured to perform a causality dependency analysis on Operating System-level (OS-level) events in heterogeneous enterprise hosts by running program code. The program code is for storing the OS-level events in the priority queue in a prioritized order based on priority scores determined from event rareness scores and event fanout scores for the OS-level events. The program code is further for processing the OS-level events stored in the priority queue in the prioritized order to provide a set of potentially anomalous ones of the OS-level events within a set amount of time. The program code is also for generating a dependency graph showing causal dependencies of at least the set of potentially anomalous ones of the OS-level events, based on results of the causality dependency analysis. The program code is additionally for initiating an action to improve a functioning of one or more of the heterogeneous enterprise hosts responsive to the dependency graph or information derived therefrom.

According to another aspect of the present invention, a computer-implemented method is provided for causality analysis of Operating System-level (OS-level) events in heterogeneous enterprise hosts. The method includes storing, by the processor, the OS-level events in a priority queue in a prioritized order based on priority scores determined from event rareness scores and event fanout scores for the OS-level events. The method further includes processing, by the processor, the OS-level events stored in the priority queue in the prioritized order to provide a set of potentially anomalous ones of the OS-level events within a set amount of time. The method also includes generating, by the processor, a dependency graph showing causal dependencies of at least the set of potentially anomalous ones of the OS-level events, based on results of the causality dependency analysis. The method additionally includes initiating, by the processor, an action to improve a functioning of one or more of the heterogeneous enterprise hosts responsive to the dependency graph or information derived therefrom.

According to yet another aspect of the present invention, a computer program product is provided for causality analysis of Operating System-level (OS-level) events in heterogeneous enterprise hosts. The computer program product includes a non-transitory computer readable storage medium having program instructions embodied therewith. The program instructions are executable by a computer to cause the computer to perform a method. The method includes storing, by the processor, the OS-level events in a priority queue in a prioritized order based on priority scores determined from event rareness scores and event fanout scores for the OS-level events. The method further includes processing, by the processor, the OS-level events stored in the priority queue in the prioritized order to provide a set of potentially anomalous ones of the OS-level events within a set amount of time. The method also includes generating, by the processor, a dependency graph showing causal dependencies of at least the set of potentially anomalous ones of the OS-level events, based on results of the causality dependency analysis. The method additionally includes initiating, by the processor, an action to improve a functioning of one or more of the heterogeneous enterprise hosts responsive to the dependency graph or information derived therefrom.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system 100 to which the present invention may be applied, in accordance with an embodiment of the present invention;

FIGS. 2-3 are block diagrams showing an exemplary resulting dependency graph 200 of forward tracking in an attack case, in accordance with an embodiment of the present invention;

FIG. 4 is a high-level block diagram showing an exemplary system architecture 400, in accordance with an embodiment of the present invention;

FIG. 5 is a diagram showing an exemplary grammar 500 to which the present invention can be applied, in accordance with an embodiment of the present invention;

FIG. 6 is a block diagram showing an exemplary computation 600 of a reference score, in accordance with an embodiment of the present invention; and

FIGS. 7-9 are flow diagrams showing an exemplary method 700 for causality analysis in homogeneous enterprise hosts, in accordance with an embodiment of the present invention.

### DETAILED DESCRIPTION OF PREFERRED EMBODIMENTS

The present invention is directed to timely causality analysis in homogeneous enterprise hosts.

In an embodiment, a technique is described that can be implemented in various forms and is interchangeably referred to herein as PRIOTRACKER. Accordingly, the terms “present invention” and “PRIOTRACKER” are used interchangeably herein. In an embodiment, PRIOTRACKER is a backward and forward causality tracker that automatically prioritizes the search for abnormal causal dependencies in the tracking process.

In an embodiment, a time-constrained causality analysis is formalized to be an optimization problem, which aims to reveal the maximum number of anomalies within a certain time limit. To distinguish abnormal operations from normal system events, the rareness of each event is quantified by developing a reference model which records common routine activities in corporate computer systems. To build such a model, we take full advantage of the homogeneous IT environment in enterprises and collect normal Operating System (OS) events from copious amounts of peer systems. Consequently, a “crowd-sourcing” based method is enabled to distill outliers from regular behaviors. We associate every event with a priority score and select the event with the highest priority score in the process of tracking. The priority score of an event is computed based on its rareness and other topological features in the causality graph. Weights are assigned to these features, which can be optimized using the Hill Climbing algorithm to find the maximum number of rare events before a given deadline. Note that although rareness and other topological features are heuristically chosen, their weights are formally assigned using a machine learning algorithm to reflect their effectiveness.

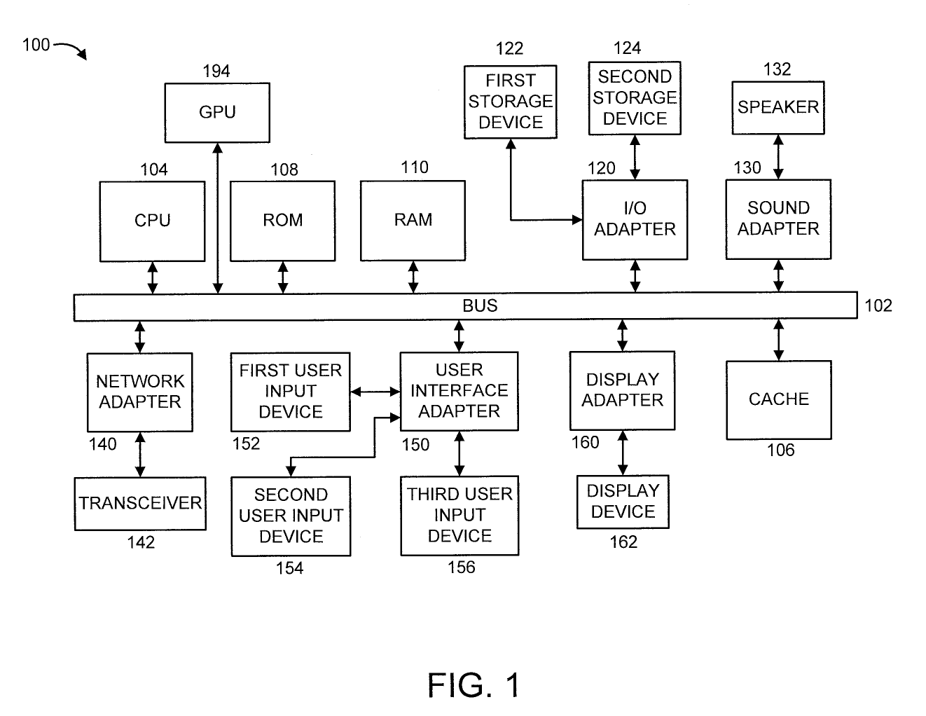

FIG. 1 is a block diagram showing an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. At least one Graphics Processing Unit (GPU) 194 is operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

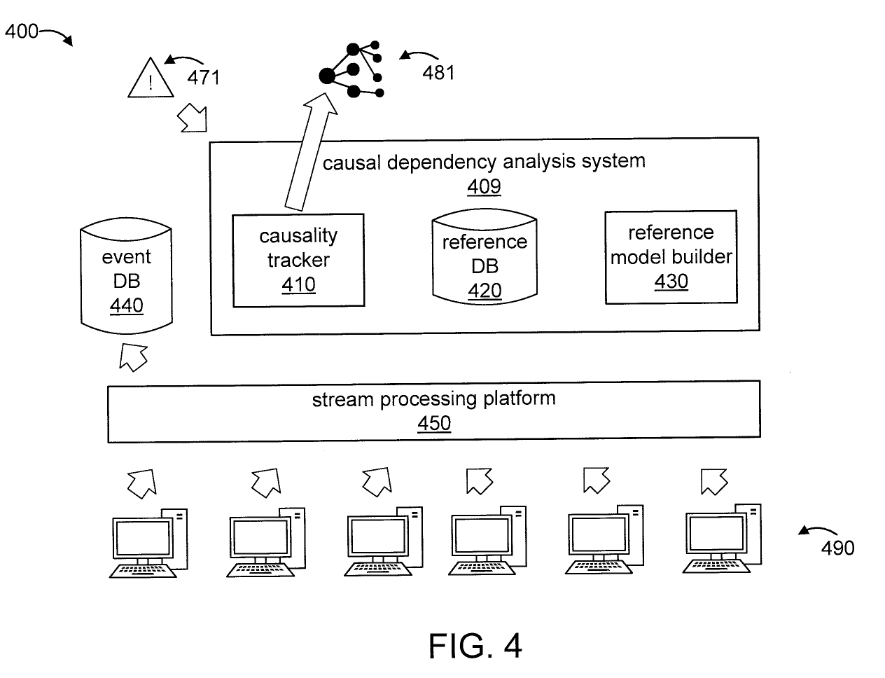

Moreover, it is to be appreciated that architecture 400 described below with respect to FIG. 4 is an architecture for implementing respective embodiments of the present invention. Part or all of processing system 100 may be implemented in one or more of the elements of architecture 400.

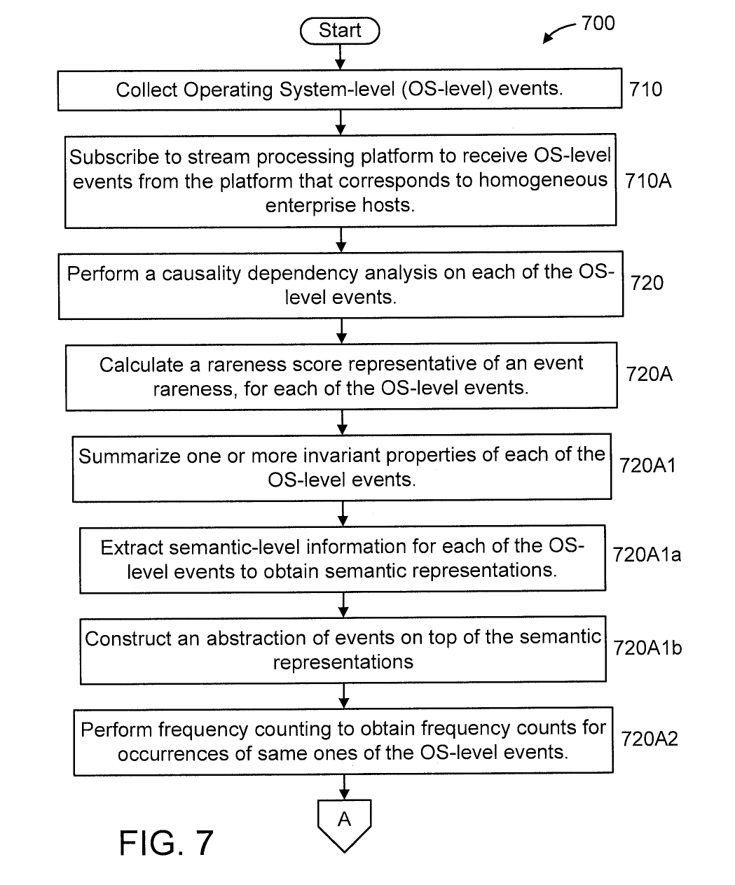

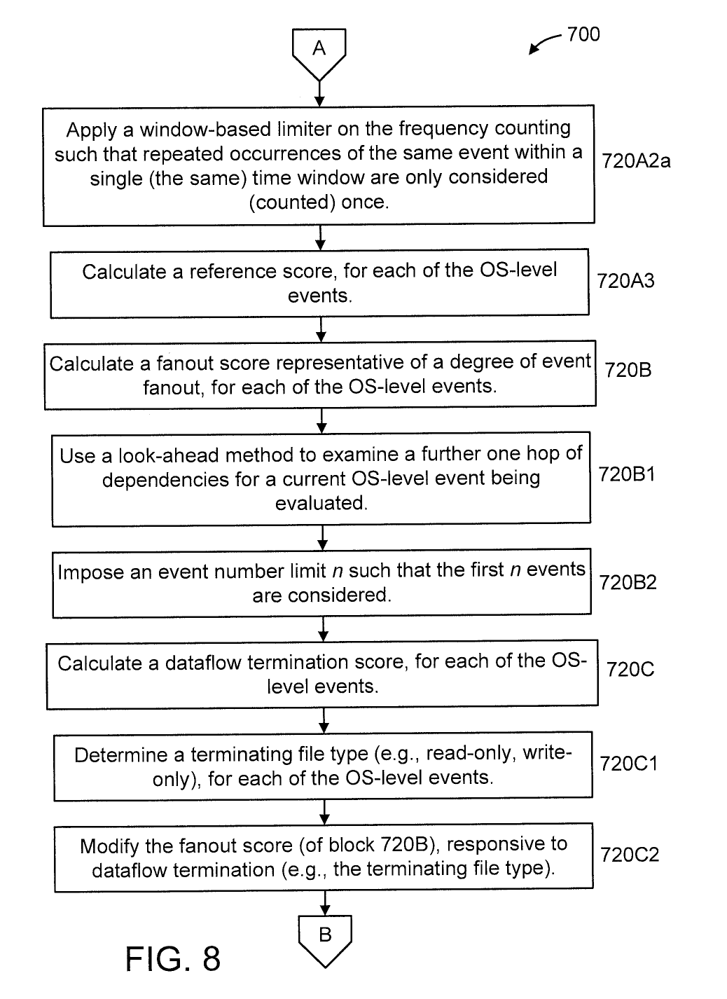

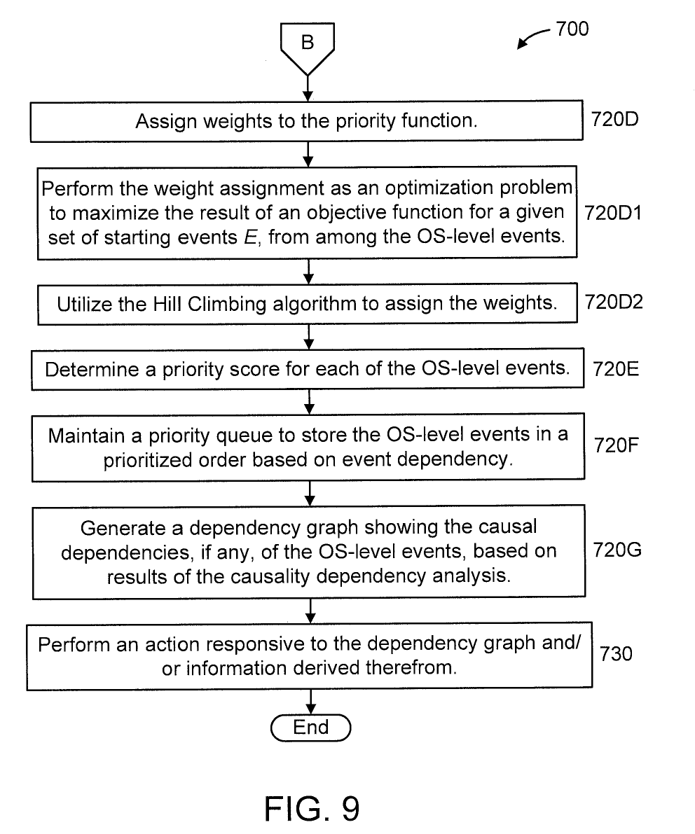

Further, it is to be appreciated that processing system 100 may perform at least part of the method described herein including, for example, at least part of method 700 of FIGS. 7-9. Similarly, part or all of architecture 400 may be used to perform at least part of method 700 of FIGS. 7-9.

A description will now be given regarding causality analysis and forward tracking graph via a motivating attack scenario example. Next, we introduce the problem statement, system architecture, and threat model.

As a motivating example, forward tracking the impact of insider related data leaks is considered. To that end, the following will be described: (1) an attack scenario; (2) a causality analysis; and (3) a forward tracking graph.

(1) Attack Scenario: An employee worked at a computer networking company which services a customer in the semiconductor industry. In order to do business with the semiconductor firm, the networking company had access to the customer's critical server which stored its most sensitive intellectual property. When the networking company employee got his new job in another semiconductor firm, he used his remaining time at his old job to steal the sensitive data. To do so, he downloaded a malicious BASH script to the data server via Hypertext Transfer Protocol (HTTP) and executed the script in order to discover and collect all the confidential documents on the server. Then, he compressed the files into a single tarball, transferred the tarball to a low-profile desktop computer via Secure Shell (SSH), and finally uploaded it to the file server via File Transfer Protocol (FTP) under his control.

(2) Causality Analysis: The incident was eventually caught manually by his colleagues in the new company, and thus reported to the victim semiconductor firm. The corporate IT administrators then started an investigation and discovered the malicious script on the data server. Furthermore, to fully recover from this attack, they also expected to locate and destroy all the copies of leaked sensitive files, so that these copies would not be accessed by any other unauthorized personnel in the future. To this end, they leveraged attack causality analysis to conduct causal dependency forward tracking, which connects the OS-level objects (files, processes and sockets) via system events in temporal order.

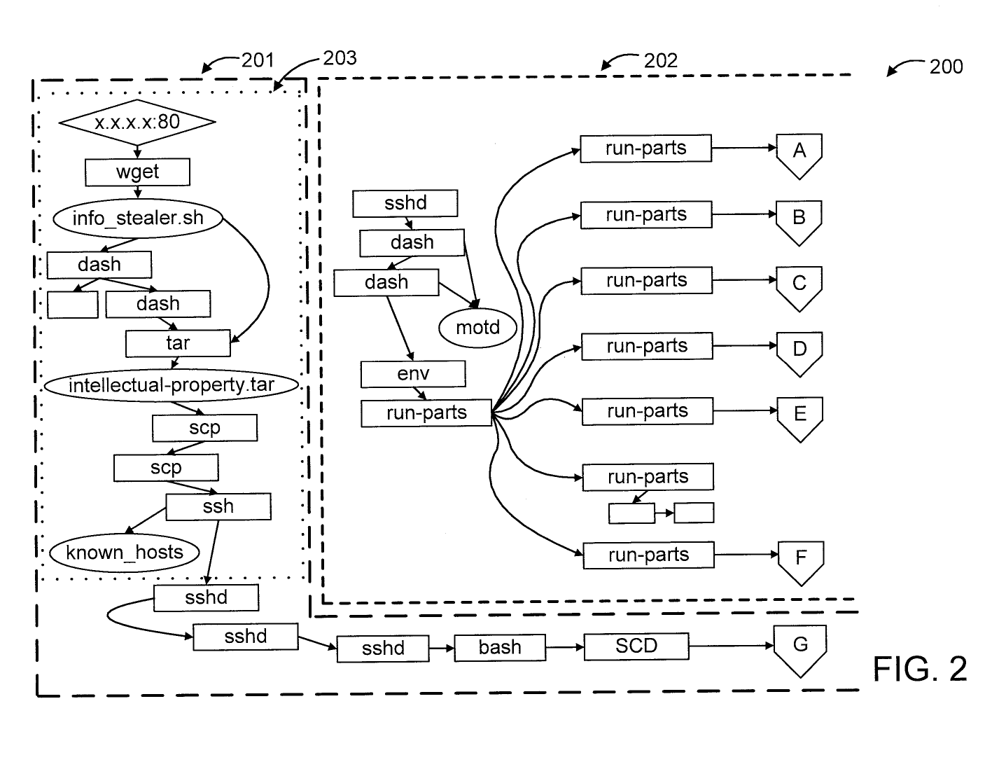

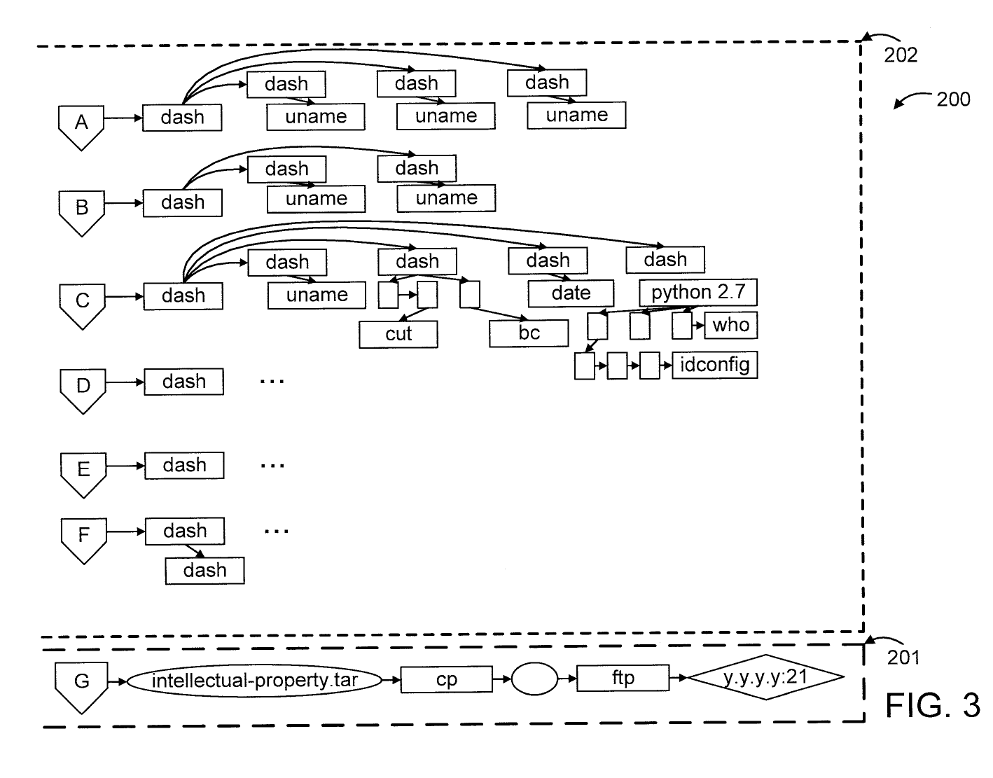

(3) Forward Tracking Graph: FIGS. 2-3 are block diagrams showing an exemplary resulting dependency graph 200 of forward tracking in an attack case, in accordance with an embodiment of the present invention. The attack case is the aforementioned attack case. In the dependency graph 200, each node represents a process, file or network socket. In particular, rectangles denote processes, ovals denote files, and diamonds denote sockets, all so denoted using solid lines. Attack traces are shown encapsulated within dashed lines 201 and relevant normal activities are shown encapsulated within other dashed lines 202. The elements of one host are shown in a rectangle 203, while elements of another host are shown outside of rectangle 203. An edge between two nodes indicates a system event involving two objects (such as process creation, file read or write, network access, etc.). Multiple edges are chained together based on their temporal order.

Particularly, FIG. 2 exposes all the subsequent system events that are caused by the data exfiltration incident. The graph begins with the network event where malicious script info_stealer.sh is downloaded by wget from x.x.x.x:80 to the server machine. The script is then executed in dash, which consequently locates sensitive files and triggers tar to compress the discovered documents into one single file, intellectualproperty.tar. The tarball is further delivered to another Linux desktop using the scp->ssh->sshd->scp channel. Once the file has reached the desktop system, a new copy is made and eventually sent to remote cite y.y.y.y:21 through ftp.

In the meantime, the result graph also reveals that sshd executes massive Linux commands through triggering a series of run parts programs. In fact, many of these Linux commands are intended to update the environmental variables, such as motd (i.e., message of the day), so as to create a custom login interface. These are relevant activities that are caused by scp operation but are relatively more common behaviors compared to transferring a previously unseen file. However, existing causality trackers cannot differentiate them from the real attack activities. Thus, they may spend a huge amount of time analyzing all the events introduced due to run-parts, even before studying data breach through ftp. To our experience, this could delay the critical attack investigation for a significant long period of time, ranging from minutes to hours depending on different cases. Unfortunately, a recent data breach report for a company discovered that nearly 90 percent of intrusions saw data exfiltration just minutes after compromise. Thus, any delay in incident response literally means more lost records, revenue and company reputation. In this case, the large causal graph is caused mostly by intensive process creations. Process forking leads to a greater amount of dependencies particularly in forward tracking than in backtracking because one process only has one parent but may have multiple children. However, it is noteworthy that the delay of attack inspection is a common problem for both forward and backward dependency tracking. Excessive file or network accesses can also take up a significant portion of analysis time in both practices.

Also note that the lack of analysis priority is orthogonal to the data quantity problem which has been intensively studied by prior data reduction efforts. Even if the overall data volume has been reduced, a security dependency analysis, without distinguishing between common and uncommon actions, can still be much delayed due to tracking the huge amount of normal activities.

A description will now be given of a problem statement to which the present invention can be applied, in accordance with an embodiment of the present invention.

To address this problem, a technique referred to herein as PRIOTRACKER is provided, which prioritizes the investigation of abnormal operations based upon the differentiation between routine and unusual events. Concretely speaking, PRIOTRACKER is expected to meet the following requirements.

Accuracy. Given sufficient analysis time, the causality tracker should capture all the critical activities, and not miss system events caused by attacks.

Time Effectiveness. Incident response is time critical and thus a practical attack investigation should be subject to time constraints. Given limited analysis time, the dependency tracking system should find the maximum number of highly abnormal behaviors.

Runtime Efficiency. The proposed prioritization technique should not introduce a significant amount of additional runtime overhead to the underlying dependency tracking system. Particularly, when analyzing the aforementioned-attack scenario, PRIOTRACKER is configured to directly reach the ftp branch without touching the majority of run parts branch in advance, so that provided a temporal limit is applied to the analysis, the real attack can still be revealed in time.

A description will now be given regarding a system architecture to which the present invention can be applied, in accordance with an embodiment of the present invention.

FIG. 4 is a high-level block diagram showing an exemplary system architecture 400, in accordance with an embodiment of the present invention.

In an embodiment, the system (PRIOTRACKER) architecture 400 can be considered to include three major components, i.e., a priority-based causality tracker 410, a reference model builder 420, and a reference database (DB) 430. These three major components can be considered to form a causal dependency analysis system 409.

The system is designed to be deployed in a large-scale and homogeneous enterprise IT environment. In this environment, OS-level events are collected from every individual host from a group of hosts 490 and are pushed to a stream processing platform 450, and are eventually stored into an event database (DB) 440. We retrieve low-level system events from Linux and Windows machines using kernel audit and Event Tracing for Windows (ETW) kernel event tracing, respectively. Specifically, we collect three types of events: (1) file events, including file read, write and execute; (2) process events, such as process create and destroy; and (3) network events, including socket create, destroy, read and write.

The reference model builder 420 subscribes to the stream in order to count the occurrences of the same events over all the hosts. The computed occurrences are then saved into our key-value store-based reference database so that they can be efficiently queried by causality tracker. Once an incident 471 happens, the triggering event is presented to our causality tracker to start a dependency analysis. The causality tracker 410 will consequently search for related events from the event database 440. At the same time, the causality tracker 410 also queries reference database in order to compute the priority score for the events to be investigated. An event bearing higher priority score will be analyzed first. In the end, the causal dependencies are generated based upon event relationships, and are presented as result graphs 481 for further human inspection.

A description will now be given regarding an exemplary threat model to which the present invention can be applied, in accordance with an embodiment of the present invention.

We define the trusted computing base (TCB) for causality analysis to be the kernel mechanisms, the backend database that stores and manages audit logs, and the causality tracker. With respect to our TCB, we assume that audit logs collected from kernel space are not tampered, since the kernel is trusted. We do consider that external attackers or insiders have full knowledge of “normal” activities, so that they can intentionally craft attacks with seemingly normal operations and may poison the reference database 430 using a burst of repeated malicious activities.

A description will now be given regarding time-constrained anomaly prioritized causality tracking, in accordance with an embodiment of the present invention.

The design details of time constrained anomaly prioritized causality tracking will now be described. First, we give the basic algorithm of PRIOTRACKER. Next, we discuss the features considered when computing the priority score of a system event. Then, we introduce the Hill Climber algorithm used for weight assignment in the priority score.

A description will now be given regarding the basic algorithm of PRIOTRACKER, in accordance with an embodiment of the present invention.

In practice, attack investigation time is not unlimited. PRIOTRACKER considers time as a key factor and aims to track more abnormal behaviors with higher potential impact with a certain time limit. Tracking tasks start from a detection point, which usually is an intrusion alert detected by the monitoring system. Algorithm 1, shown in TABLE 1, illustrates our basic algorithm to perform a time constrained causality tracking. In general, we build dependencies between OS-level events. However, to enable timely security causality analysis, we prioritize the dependency tracking of abnormal events, in contrast to previous work which blindly selects the next event for processing.

TABLE 1
Algorithm 1 Dependency Tracking Algorithm

| | |
|---|---|
| 1: | procedure PRIOTRACK(se, Tₗᵢₘᵢₜ) |

| | |
|---|---|
| 2: | PQ ← Ø |
| 3: | PQ.INSERT(se, Priority(se)) |
| 4: | while ! PQ.ISEMPTY( ) and T_{analysis} < Tₗᵢₘᵢₜ do |

| | |
|---|---|
| 5: | e ← PQ.DEQUEUE( ) |
| 6: | G ← G ∪ e |
| 7: | E ← COMPUTEDEPS(e) |
| 8: | for ∀e′ ∈ E do |

| | |
|---|---|
| 9: | PQ.INSERT(e′, Priority (e′)) |

| | |
|---|---|
| 10: | end for |

| | |
|---|---|
| 11: | end while |
| 12: | return G |

| | |
|---|---|
| 13: | end procedure |

More concretely, our dependency tracker internally maintains a Priority Queue (PQ) to hold all the events that wait for processing. This queue is sorted in descending order based on the priority scores of enclosed events, so that the event with highest priority is always placed at the head and will be processed first. Upon receiving a Starting Event (se), our tracker computes its priority score using function Priority( ) and adds it into this queue. Then, PRIOTRACKER iteratively processes each item until the queue becomes empty or the given analysis time limit Tₗᵢₘᵢₜ is reached. In each iteration, it fetches an event from the head of queue, adds this event to the result graph G, and invokes COMPUTEDEPS( ) to compute its causal dependencies based on temporal relationships. COMPUTEDEPS( ) returns a set of events E for further analysis. Then, we compute the priority score for each element in this set before inserting them into the priority queue. In the end, Algorithm 1 outputs the dependency graph G for forensic analysis. Events that are not tracked within the time limit are not included in the resulting graph but are stored in the database for further analysis. PRIOTRACKER supports across-host tracking by performing Internet Protocol (IP) channel event matching. For an IP channel event on host A talking to host B, we search for its match on host B with the reverse of the IP and port information, which are, within some tolerance, occurring at the same time.

A description will now be given regarding a priority score, in accordance with an embodiment of the present invention.

To that end, a description will now be given of important factors relative to a priority score, in accordance with an embodiment of the present invention.

Important Factors: We consider three factors to be important when determining the priority of system events to be processed, as follows.

Rareness of Events. In general, attack behaviors and malware activities are deviated from massive normal operations. Particularly, APT incidents often enable zero-day attacks, which by nature have never been observed in regular systems. As a result, special attention needs to be paid to rarer events compared to routine activities.

Fanout. As illustrated in our motivating example, routine system operations can be performed in a batch, which include multiple sub-operations. Besides, regular system activities (e.g., creating or accessing numerous temporary files) may happen periodically over time. This, in turn, generates events with very high fanout in a dependency graph (up to tens of thousands), which does not contribute to attack forensics. In addition, analysis of causalities with high fanout can be very time-consuming and therefore may delay or even disable timely investigation of other attack traces. Essentially, there exists a trade-off between time effectiveness and analysis coverage, where a balance needs to be struck.

Dataflow Termination. To invade an enterprise system, attackers have to first exert an external influence on internal system objects (e.g., malware dropping, malicious input to vulnerable network services, etc.) to persist. Then, the attackers can further use the compromised persistent objects (e.g., malicious executables, victim long-running services) to cause impact on other parts of the system. Consequently, a file without being written in the past is less critical for backtracking intrusions, while a file that has never been read or executed so far is less interesting for tracking attack consequences forward. The former one is referred to as the “read-only” pruning heuristic in backtracker. The latter case, however, cannot be completely ignored because a currently “write-only” file may still be accessed at a future point. Hence, to generate the priority score for each event, we need to first compute the scores for edge rareness, fanout and dataflow termination, respectively

A description will now be given of a rareness score relative to a priority score, in accordance with an embodiment of the present invention.

Rareness Score: First, we define the rareness score of an event rs(e) based upon our reference model as follows:

$$rs ( e ) = \{ \begin{matrix}1 , & if e has not been observed by reference model \\ \frac{1}{ref ( e )} , & otherwise \end{matrix}$$

ref(e) is the reference score of event e, which is computed by reference model according to the historical occurrence of e. We elaborate on the computation of the reference score hereinbelow.

A description will now be given of a fanout score relative to a priority score, in accordance with an embodiment of the present invention.

Fanout Score: Second, we formalize the fanout score of an event fs(e) to be the reciprocal of its fanout:

$$fs ( e ) = \frac{1}{fanout ( e )} .$$

An event with a higher fanout score will be examined first. Note that when we compute fanout, we do not consider outgoing socket edges whose destinations are external networks or specific internal servers (e.g., DNS), which are not under our monitoring and thus will not be further tracked in the first place. We prefer edges with low fanout due to the consideration of both security and efficiency. Analyzing causal relations with huge fanout is often very slow because dependencies grow exponentially. Thus, putting them first may lose the chance to explore other system dependencies which could also be caused by attacks. In contrast, analysis of causalities with lower fanout is comparatively simpler and costs much less time to complete. Even if, in the worst-case scenario, fast-tracking an event with low fanout does not reveal any attack traces, it only introduces a small amount of delay to the examination of other complex causalities. We admit, as a potential evasion technique, an attacker may attempt to leverage system causality with high fanout to hide their attack footprints, in order to delay our analysis. However, it is worth noting that, though we deprioritize paths with high fanout, we do not prune off them as prior work does. If an attack is indeed buried in branches bearing high fanout, given enough time and computation resources, our tracker can eventually reach that point. Besides, an attack cannot be launched solely using complex dependencies with high fanout, while the other portion of attack-related causalities can still be discovered by our approach from numerous normal edges in a faster fashion. Since the entire attack footprints are logically connected, any uncovered portion can help human experts find the remaining ones. On the contrary, without prioritization, processing benign dependencies with huge fanout can excessively consume computing resources. Consequently, none of the attack traces can be reached before analysis deadline, and therefore the entire attack is missed.

A description will now be given of a dataflow termination relative to a priority score, in accordance with an embodiment of the present invention.

Dataflow Termination: Terminated dataflow is a special case, where fanout equals zero. Therefore, we complete our definition of fanout score by also checking whether an event has further impacts:

$$fs ( e ) = \{ \begin{matrix}0 , & if e reaches a read \text{-} only file in backtracking \\ σ , & if e reaches a write \text{-} only file in forward tracking \\ \frac{1}{fanout ( e )} , & otherwise \end{matrix}$$

Hence, if backward dataflow is terminated due to read-only files, we deprioritize the analyses of associated events via assigning 0 to the score. However, when forward dataflow ends with “write-only” files, we do not completely rule out the possibility that these files will later be accessed. Therefore, we instead give them a lower but non-zero score a. Empirically, we set σ to be 0.3.

A further description will now be given of priority score, in accordance with an embodiment of the present invention.

Priority Score: The priority score of each event can be derived from the composition of these factors.

Definition 1. The Priority Score of a system event, Priority(e), is the weighted sum of rareness score rs(e) and fanout score fs(e):

Priority(e)=α×rs(e)+β×fs(e) (1)

where α and β are the weights that need to be determined. An event with higher priority score will be investigated first.

A description will now be given regarding weight assignment, in accordance with an embodiment of the present invention.

The next step is to give a proper weight to each parameter of the priority function. Ideally, when weights are correctly assigned, we expect our dependency tracker to find the maximum amount of attack traces within a finite time bound. Nevertheless, it is very hard, if not impossible, to measure the relatedness between a single event between two OS-level objects and an attack, especially before the attack is completely known. This is by nature due to the diversity and randomness of cybercrimes committed by human attackers, and by itself can be a challenging research problem. Therefore, to date, expert knowledge has to be kept in the loop to evaluate automatically generated security causality graphs and to draw a decisive conclusion. To address this problem, we instead use rareness as a metric to approximate the connection between a causal relation and unknown attacks. As a result, our goal of weight assignment is to enable our tracker to uncover as many unusual events as possible within a certain time limit. Admittedly, an adversary could utilize many normal system operations when launching an attack, and therefore the overall amount of rare events does not necessarily indicate the presence of attacks. However, at certain points of a stealthy crime, an attacker has to perform some harmful and thus abnormal operations, such as data exfiltration or system tampering, in order to serve the purpose of the attack. Then, a discovery of more unusual activities may increase the chance of capturing real attack footprints. To achieve the discovery of the maximum number of unusual events, we need to strike a balance among the aforementioned-factors. On one hand, at every step of dependency tracking, we always expect to choose a rare and impactful event over a common or uninteresting one. On the other hand, we also hope to quickly explore the entire search space and find the direction that leads to more rare activities. Essentially, this is a global optimization problem, which we define as follows:

Definition 2. The Weight Assignment is an optimization problem to maximize the result of an objective function for a given set of starting events E:

max f(E,(α,β))=Σ_{e∈E}EdgeCount_{θ}(PrioTrack(α,β)(e,Tₗᵢₘᵢₜ))s.t.0<α<1,α+β=1 (2)

where α and β are the weight parameters for rs and fs, respectively. These scores are further used to derive the priority score in dependency tracking. The EdgeCount function counts the number graph edges whose rareness score is greater than a given threshold θ. Empirically, we set 0 to be 0.1 and set time limit Tₗᵢₘᵢₜ to be 60 minutes. Note that these values can be customized for specific environments and security requirements. We can then utilize the Hill Climbing algorithm to achieve the optimization of Equation 3. This algorithm can gradually improve the quality of weight selection via a feedback-based method. We have implemented such a feedback loop, which takes a set of starting events E and an initial weight vector (α, β) as inputs. To create the starting event set E, we randomly select 1,113 system events, within a time span of 10 months from August 2016 to May 2017, which lead to excessively large dependency graphs (up to 73,221 edges with 2,391 edges on average). At each iteration, the algorithm adjusts an individual element in the weight vector and determines whether the change improves the value of objective function f(E,(α, β)). If so, such a positive change is accepted, and the process continues until no positive change can be found anymore. Eventually, the algorithm produces the optimized weight parameters, where α=0.27 and β=0.73.

Note that the rareness and fanout features demonstrate a trade-off between analysis coverage and time effectiveness. The fact that the weight of fanout is three times as much as that of rareness indicates the trained tracking system prefers to quickly expand the search area to reach a global optimal. As a result, on one hand, it tends to prioritize low-fanout events and avoid high-fanout events that cause the search to sink into a very busy local neighborhood. On the other hand, it depends less on the rareness score of the current event under examination because it cannot adequately reflect the overall rareness of following events. In an embodiment, we have developed the priority-based dependency tracker in 20K lines of Java code. When acquiring the enabling information (i.e., rareness, fanout and write-only/read-only), we pay special attention to runtime efficiency in order to cope with the massive amounts of system events collected from large enterprises. Particularly, we introduce several optimization techniques to accelerate data query as follows.

(1) In-Memory Key-Value Store: Our tracking algorithm requires frequent access to reference database in order to query reference score of individual events. Traditional database persisted on hard disks cannot satisfy such performance requirements. As a result, we store the reference data in RocksDB, which on one hand enables an in-memory key-value store for fast access, and on the other hand can still persist data in the traditional way.

(2) Event Cache: To compute the fanout of an event or to determine if an event reaches a read-only or write-only file, we enable a look-ahead method to examine a further one hop of dependencies. In fact, these additional query results are not only used for the current computation of priority scores, but also later become part of a result dependency graph. Thus, to avoid redundant query overhead, we cache these results for future usages.

(3) Look-Ahead with a Limit: Sometimes, the fanout of an event is extremely high. For instance, a Firefox® process may touch hundreds of temporary files. In this case, counting the exact fanout via database query is very time-consuming, and could lead to degradation of runtime efficiency. Besides, in such a case, the exact value of fanout becomes less interesting in terms of computing and comparing the priority score. Therefore, we approximate the fanout by putting a limit n on the query, so that it only looks for the first n events that are dependent on the current one. In effect, if the fanout is greater than n, the fanout score fs(e) is in practice defined to be 1/n instead of 1/fanout(e).

A description will now be given regarding a reference model, in accordance with an embodiment of the present invention.

The reference model quantifies the rareness of system events and helps distinguish the anomalies from noisy normal system operations. First, we give the details of data collection in an enterprise IT system. Next, we formally define the reference score of a system event, which is a crucial factor in the rareness score.

A description will now be given regarding data collection with respect to the reference model, in accordance with an embodiment of the present invention.

To build the reference model of system events, we collect and compute the statistical data for event occurrences on 54 Linux and 96 Windows machines used daily for product development, research and administration in an enterprise IT system. Particularly, we make special efforts to ensure the representativeness, generality and robustness of the reference model.

A description will now be given regarding discovery of homogeneous hosts with respect to data collection, in accordance with an embodiment of the present invention.

The basic idea of the reference model is to identify common behaviors across a group of homogeneous hosts. Therefore, to enable this technique, homogeneity of the hosting environment is required. Otherwise, the generated model cannot be representative. In general, enterprise IT systems could satisfy such a requirement due to the overall consistency of daily tasks. However, it is still possible that computers from individual departments in the same corporate environment carry on different types of workloads, and therefore their system behaviors may vary. To be able to discover the homogeneous groups, we performed a community detection within an enterprise. Particularly, we utilized the Mixed Membership Community and Role model (MMCR) and eventually discovered 3 communities within 150 machines. In fact, these 3 communities can be roughly mapped to three different departments in this company. Hence, we collect system events from 3 communities separately and build a reference model for each of the detected communities. In this way, the generated models can be adapted for individual environments.

A description will now be given regarding abstraction of events with respect to data collection, in accordance with an embodiment of the present invention.

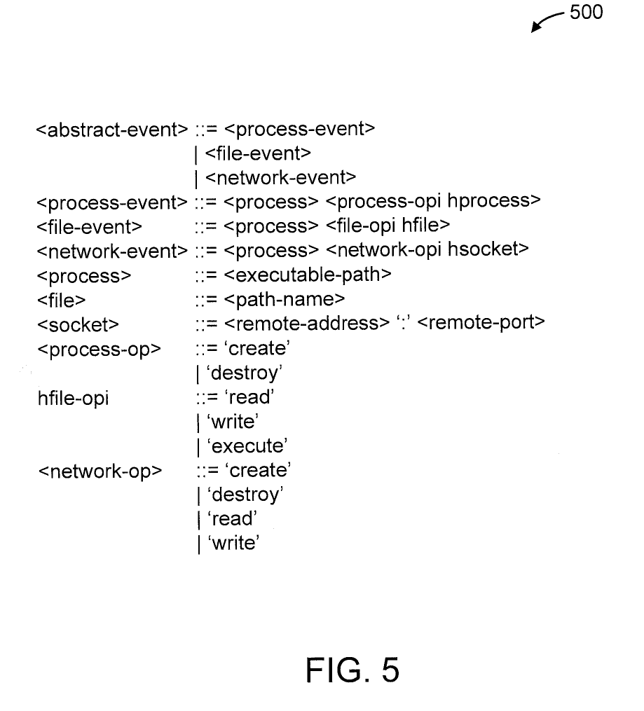

To quantify the rareness of system events, the reference model builder 320 expects to count the occurrences of same events. Nonetheless, OS events are highly diverse over time or across hosts, even if they bear the same semantics. For example, the same program can bear several process IDs when it has been executed multiple times. Two identical system files are assigned with different inode numbers on two Linux hosts. To capture high-level common behaviors, while tolerating low-level system diversity, we summarize events using their invariant properties. To this end, we first extract semantic level information from system objects. Particularly, a process is modeled using its executable path, a file is represented by its path name, and a socket is denoted with a remote IP address plus remote port number. Then, on top of these representations, we construct the abstraction of events, which follows a grammar illustrated in FIG. 5 using Backus-Naur Form (BNF). That is, FIG. 5 is a diagram showing an exemplary grammar 500 to which the present invention can be applied, in accordance with an embodiment of the present invention. As a result, events sharing the same abstraction are considered to be the same ones. Note that, due to customization, the path name of the same system files may still be different on individual hosts. For example, the user account name can be part of the path name which, in turn, becomes unique for each user. To allow such differences, normalization of the path name is needed. We address this problem by retrieving a mapping between user account name and the corresponding home directory name from both local machines and global directory services (e.g., active directory, NIS), and replacing the home directory name in the path with the same wildcard.

A description will now be given regarding a time window with respect to data collection, in accordance with an embodiment of the present invention.

The naive way to count the occurrence of an event is simply increasing the counter, whenever a same one is observed. Nevertheless, this may be subject to poisoning attacks. An adversary can intentionally create repeated malicious activities, and such a burst of vicious events may trick the naive model to believe that these are common behaviors due to their high counts. To address this problem, we introduce a time window when increasing counters. Within a single time window, the repeated occurrence of an event on the same host will only be considered once. As a result, a sudden spike of recurring events only causes limited impacts. We configure the time window to be one week. This is because enterprises are generally operated on a weekly basis. Besides, host behaviors within and without work hours, or system activities on weekdays and weekends can be fairly different by nature. Thus, a time window greater than a week can avoid such a vibration of event occurrence while preserving high-level consistency of corporate workloads. Note that the time window is configurable and can be adjusted to different enterprise systems.

A description will now be given regarding a reference score with respect to the reference model, in accordance with an embodiment of the present invention.

With the aforementioned factors being considered, we formally define the reference score of a system event.

Definition 3. The Reference Score ref of an OS-level event e is its accumulative occurrence on all homogeneous hosts for all weeks, as follows:

ref(e)=E_{h∈hosts}Σ_{w∈weeks} count(e,w,h) (3)

where hosts is the set of homogeneous machines, weeks represents the set of weeks when data is collected, and

$$count ( e , w , h ) = \{ \begin{matrix}1 , & if e occurred in week w on host h \\ 0 , & otherwise \end{matrix}$$

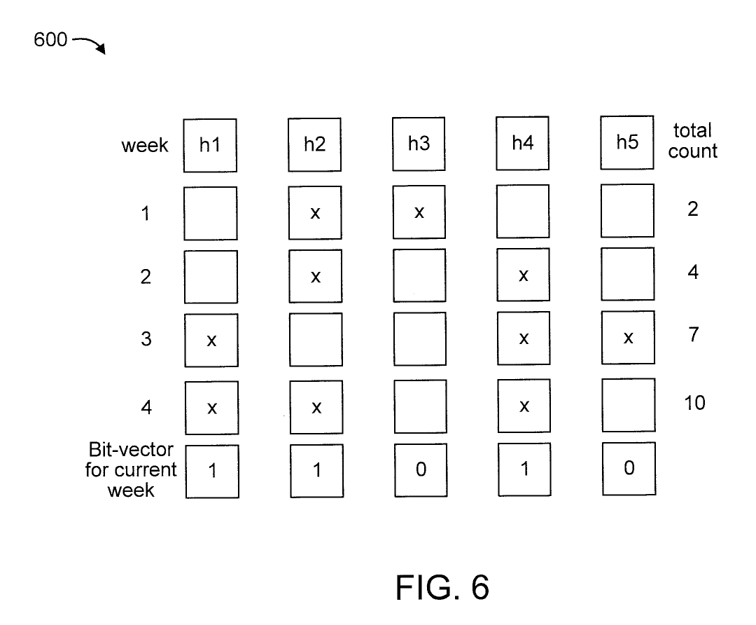

A description will now be given regarding an implementation to which the present invention can be applied, in accordance with an embodiment of the present invention. When computing the score, we in fact update it incrementally using an online algorithm. FIG. 6 is a block diagram showing an exemplary computation 600 of a reference score, in accordance with an embodiment of the present invention. As depicted in FIG. 6, we maintain a total count and a bit-vector of current week for each abstracted event. The bit-vector indicates the occurrence of event on all hosts in the current week, where each bit represents a host. The present data can only affect the existence of an event in the current week, and thus will be checked against the bit-vector. By the end of each week, the total count is updated using the bit-vector and the vector will be cleared. In this way, we only store the minimum necessary data so as to ensure efficient storage and query.

FIGS. 7-9 are flow diagrams showing an exemplary method 700 for causality analysis in homogeneous enterprise hosts, in accordance with an embodiment of the present invention.

At block 710, collect Operating System-level (OS-level) events. In an embodiment, the OS-level events are obtained from audit logs collected from kernel space. Of course, other sources can be used, while maintaining the spirit of the present invention.

In an embodiment, block 710 can include block 710A.

At block 710A, subscribe to stream processing platform to receive OS-level events from the platform that corresponds to homogeneous enterprise hosts.

At block 720, perform a causality dependency analysis on each of the OS-level events. In an embodiment, the causality dependency analysis can be performed using the reference database and/or the event database.

In an embodiment, block 720 can include one or more of blocks 720A-720G.

At block 720A, calculate a rareness score representative of an event rareness, for each of the OS-level events.

In an embodiment, block 720A can include one or more of blocks 720A1-720A3.

At block 720A1, summarize one or more invariant properties of each of the OS-level events. In an embodiment, the one or more invariant properties can be summarized using common high-level behaviors, while tolerating low-level system diversity.

In an embodiment, block 720A1 can include one or more of blocks 720A1a and 720A1b.

At block 720A1a, extract semantic-level information for each of the OS-level events to obtain semantic representations.

At block 720A1b, construct an abstraction of events on top of the semantic representations (obtained at block 720A2). The abstraction can use a particular grammar including, but not limited to, for example, Backus-Naur Form (BNF).

At block 720A2, perform frequency counting to obtain frequency counts for occurrences of same ones of the OS-level events.

In an embodiment, block 720A2 can include block 720A2a.

At block 720A2a, apply a window-based limiter on the frequency counting such that repeated occurrences of the same event within a single (the same) time window are only considered (counted) once.

At block 720A3, calculate a reference score, for each of the OS-level events. In an embodiment, the reference score can be represented using a bit-vector, where the bit-vector indicates the occurrence of an event on all hosts in the current week (or other time period) and each bit represents a particular one of multiple hosts.

At block 720B, calculate a fanout score representative of a degree of event fanout, for each of the OS-level events.

In an embodiment, block 720B can include one or more of blocks 720B1 and 720B2.

At block 720B1, use a look-ahead method to examine a further one hop of dependencies for a current OS-level event being evaluated.

At block 720B2, impose an event number limit n such that the first n events are considered.

At block 720C, calculate a dataflow termination score, for each of the OS-level events.

In an embodiment, block 720C can include one or more of blocks 720C1 and 720C2.

At block 720C1, determine a terminating file type (e.g., read-only, write-only), for each of the OS-level events.

At block 720C2, modify the fanout score (of block 720B), responsive to dataflow termination (e.g., the terminating file type).

At block 720D, assign weights to the priority function. In an embodiment, the weights are assigned to the rareness score, the fanout score, and the dataflow termination score.

In an embodiment, block 720D can include one or more of blocks 720D1 and 620D2.

At block 720D1, perform the weight assignment as an optimization problem to maximize the result of an objective function for a given set of starting events E, from among the OS-level events.

At block 720D2, utilize the Hill Climbing algorithm to assign the weights.

At block 720E, determine a priority score for each of the OS-level events. In an embodiment, the priority score, Priority(e), for each of the OS-level events is as follows:

Priority(e)=α×rs(e)+β×fs(e),

where rs(e) is the rareness score, fs(e) is the fanout score, and α and β are the weights for the rareness and fanout scores, respectively.

At block 720F, maintain a priority queue to store the OS-level events in a prioritized order based on event dependency. In an embodiment, the OS-level events are stored in descending order of priority so that the highest priority OS-level event is the next to be processed from the priority queue.

At block 720G, generate a dependency graph showing the causal dependencies, if any, of the OS-level events, based on results of the causality dependency analysis.

At block 730, perform an action responsive to the dependency graph and/or information derived therefrom. The action can be performed to improve the functioning of one or more hosts or related devices to which the OS-level events relate. The action can be a curative action to fix a detected problem and/or prevents its spread. The action can involve blocking a deficient pathway(s) and providing a non-deficient pathway(s) in its place, preventing use of a deficient system element(s) and providing a replacement non-deficient system element(s), and so forth. The preceding actions are merely illustrative and, thus, other actions can also be performed in accordance with the teachings and spirit of the present invention, depending upon the implementation. Information can be derived from the graph using a variety of techniques including graph analysis, graph to text conversion where keywords in the text conversion initiate the action, and so forth.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system, comprising:
a memory device for storing program code;
a priority queue;
a processor, operatively coupled to the memory device and the priority queue, configured to perform a causality dependency analysis on Operating System-level (OS-level) events in heterogeneous enterprise hosts by running program code to
store the OS-level events in the priority queue in a prioritized order based on priority scores determined from event rareness scores and event fanout scores for the OS-level events;
process the OS-level events stored in the priority queue in the prioritized order to provide a set of potentially anomalous ones of the OS-level events within a set amount of time;
generate a dependency graph showing causal dependencies of at least the set of potentially anomalous ones of the OS-level events, based on results of the causality dependency analysis; and
initiate an action to improve a functioning of one or more of the heterogeneous enterprise hosts responsive to the dependency graph or information derived therefrom.

2. The system of claim 1, further comprising a reference database, operatively coupled to the processor, for storing frequency counts for occurrences of same ones of the OS-level events across all of the homogeneous enterprise hosts.

3. The system of claim 2, wherein the reference database is a key-value database.

4. The system of claim 2, wherein at least the reference database is comprised in the memory device.

5. The system of claim 1, wherein the priority scores for each of the OS-level attacks are weighted with respect to the rareness scores and the event fanout scores corresponding thereto.

6. The system of claim 5, wherein an optimization problem is used to maximize a result of an objective function for a given subset of the OS-level events.

7. The system of claim 1, wherein the rareness score for a given one of the OS-level events is calculated based on a reference score for the given one of the OS-level events, and wherein the rareness score is represented using a bit vector to indicate an occurrence of the given one of the OS-level events on all of multiple hosts in a given time period, and each bit represents a particular one of the multiple hosts.

8. The system of claim 1, further comprising an event database for storing the OS-level events upon collecting the OS-level events from the homogeneous enterprise hosts.

9. The system of claim 1, wherein the processor is further configured to perform the causality dependency analysis by running program code to build and update a reference model for use by the causality dependency analysis to calculate the rareness score.

10. The system of claim 1, wherein the OS-level events comprise file events, process events, and network events.

11. The system of claim 1, wherein the priority queue is processed until the priority queue is a condition is satisfied, the condition selected from the group consisting of the priority queue being empty and an expiration of the set amount of time.

12. The system of claim 11, wherein events remaining in the priority queue subsequent to the expiration of the set amount of time are excluded from the causal dependency graph and stored for further subsequent analysis.

13. The system of claim 1, further comprising a display device for displaying the causal dependency graph to a user.

14. A computer-implemented method for causality analysis of Operating System-level (OS-level) events in heterogeneous enterprise hosts, comprising:
storing, by the processor, the OS-level events in a priority queue in a prioritized order based on priority scores determined from event rareness scores and event fanout scores for the OS-level events;
processing, by the processor, the OS-level events stored in the priority queue in the prioritized order to provide a set of potentially anomalous ones of the OS-level events within a set amount of time;
generating, by the processor, a dependency graph showing causal dependencies of at least the set of potentially anomalous ones of the OS-level events, based on results of the causality dependency analysis; and
initiating, by the processor, an action to improve a functioning of one or more of the heterogeneous enterprise hosts responsive to the dependency graph or information derived therefrom.

15. The computer-implemented method of claim 14, further comprising storing, in a reference database operatively coupled to the processor, frequency counts for occurrences of same ones of the OS-level events across all of the homogeneous enterprise hosts.

16. The computer-implemented method of claim 14, wherein the priority scores for each of the OS-level attacks are weighted with respect to the rareness scores and the event fanout scores corresponding thereto.

17. The computer-implemented method of claim 16, wherein an optimization problem is used to maximize a result of an objective function for a given subset of the OS-level events.

18. The computer-implemented method of claim 14, wherein the rareness score for a given one of the OS-level events is calculated based on a reference score for the given one of the OS-level events, and wherein the rareness score is represented using a bit vector to indicate an occurrence of the given one of the OS-level events on all of multiple hosts in a given time period, and each bit represents a particular one of the multiple hosts.

19. The computer-implemented method of claim 14, wherein the method further comprises building and updating, by the processor, a reference model for use by the causality dependency analysis to calculate the rareness score.

20. A computer program product for causality analysis of Operating System-level (OS-level) events in heterogeneous enterprise hosts, the computer program product comprising a non-transitory computer readable storage medium having program instructions embodied therewith, the program instructions executable by a computer to cause the computer to perform a method comprising:
storing, by the processor, the OS-level events in a priority queue in a prioritized order based on priority scores determined from event rareness scores and event fanout scores for the OS-level events;
processing, by the processor, the OS-level events stored in the priority queue in the prioritized order to provide a set of potentially anomalous ones of the OS-level events within a set amount of time;
generating, by the processor, a dependency graph showing causal dependencies of at least the set of potentially anomalous ones of the OS-level events, based on results of the causality dependency analysis; and
initiating, by the processor, an action to improve a functioning of one or more of the heterogeneous enterprise hosts responsive to the dependency graph or information derived therefrom.
